(19) United States
(12) Patent Application Publication
(10) Pub. No.: US 2016/0158696 A1
(43) Pub. Date: Jun. 9, 2016

(54) TREATMENT PROCESS OF PHOSPHOROUS PENTAFLUORIDE

(71) Applicant: KANTO DENKA KOGYO CO., LTD., Tokyo (JP)

(72) Inventors: Katsuhiro SAITO, Tokyo (JP); Shinji MITA, Tokyo (JP); Hiromi OYA, Okayama (JP); Shinsuke KATAYAMA, Okayama (JP); Yoshimasa SAKURAI, Gunma (JP); Shogo MASAUJI, Okayama (JP); Yuuki KUBOTA, Okayama (JP); Hidehito FUJISAWA, Okayama (JP)

(21) Appl. No.: 14/901,548

(22) PCT Filed: May 26, 2014
(86) PCT No.: PCT/JP2014/063783

§ 371 Date: Dec. 28, 2015

(30) Foreign Application Priority Data
Jun. 27, 2013 (JP) 2013-135338

(51) Int. Cl. B01D 53/68; C02F 1/66; C02F 1/70; C02F 1/02

(52) U.S. Cl. CPC B01D 53/68; C02F 1/025; C02F 1/66; C02F 1/70; C02F 2101/14

(57) ABSTRACT

A treatment process of PF₅ including an absorption step for inducing absorption of PF₅ by an acidic solution containing an acid to obtain a solution containing PF₅A⁻, an adjustment step to adjust concentration of HCl in the solution, and a thermolysis step for heating the solution containing PF₅A⁻ ions obtained in the absorption step or the adjustment step to decompose the solution to an acidic mixture containing H₃PO₄ and HF.

### TECHNICAL FIELD

The present invention relates to a process for preventing the spread of all or a part of PF₅ that was produced or used excessively when producing or using PF₅, which is useful as an electrolyte of lithium ion secondary batteries or a semiconductor material, or for detoxifying such PF₅.

### BACKGROUND ART

Phosphorous pentafluoride (PF₅) is an industrially useful material in the field of semiconductors or batteries. However, PF₅ is known for its high toxicity. Since a surplus (an excessive amount) of PF₅ may build-up or a large amount of PF₅ may be produced purposefully in the production or use of PF₅, it is necessary to prevent its emission into the atmosphere as well as its discharge by incorporation in drainage.

It is thus required to detoxify PF₅ and to reduce the burden placed on the environment. PF₅ of a high concentration may be directly recovered by cryogenic distillation method. Suggestions for PF₅ of a low concentration, on the other hand, include decomposing it to fluoride ions, fluorine compound ions, phosphorous ions, phosphorous compound ions, etc. to recover them as a fluorine source and a phosphorous source, or to fix them after decomposition.

PF₅ gas is decomposed under the presence of water or alkali, but the decomposition rate is slow, so it would be inefficient to decompose PF₅ gas by the conventional treatment process through absorption in water or an alkaline solution.

Under such circumstances, a generally known recovery process is to recover PF₅ as LiPF₆ under the presence of a lithium source (Li source). PF₅ that has been fixed to a Li source, etc. becomes a PF₆⁻ ion in the aqueous solution. The PF₆⁻ ions are treated as shown for example in Non-Patent Document 1, that is, by mixing the 1 wt % LiPF₆ solution and a 35 wt % hydrochloric acid at varying ratios, leaving them to stand overnight, then adding lime hydrate (Ca(OH)₂) to neutralize and filter the mixture. However, such method of fixing to the Li source is unrealistic when the PF₅ gas to be recovered has a low concentration, since its reaction rate and recovery rate will be low. In addition, this process requires fixing the PF₅ gas to a costly Li source, etc., so it is not economical.

On the other hand, Patent Document 1 describes a process for treating wastewater containing fluorophosphoric acid with sulfuric acid. It is assumed that the wastewater includes PF₆⁻ ions. Detoxification is achieved in the process of Patent Document 1 by adding sulfuric acid to the wastewater and performing heat treatment at a temperature of 20 to 80° C., then adding a calcium compound to fix fluorine ion as calcium fluoride.

However, when sulfuric acid is used, a large amount of calcium sulfate is generated as waste during neutralization, which makes the cost of treatment enormous, so this method is also not economical.

Patent Document 2 describes a fixation/removal process of fluorine and phosphorous in a wastewater containing a fluorophosphoric acid compound. This wastewater includes PF₆⁻ ions. Fixation/removal of fluorine and phosphorous is achieved in this process by adding hydrochloric acid to the wastewater to achieve a fluorophosphoric acid compound concentration in the wastewater of 2 to 10 wt %, heating the wastewater to a temperature of between 80° C. and the boiling point of wastewater to decompose the wastewater into HF and H₃PO₄, at the same time, treating the generated hydrogen chloride gas in a compressor, then adding calcium salt to the decomposed wastewater.

However, when wastewater is heated to 80° C. or higher after adding hydrochloric acid to remove fluorine and phosphorous, a large amount of hydrogen chloride gas is generated, bringing about gas treatment problems. This process causes a large amount of hydrogen chloride, required for decomposing PF₆⁻ ions, to escape the system, so the drop of the decomposition rate of PF₆⁻ ions is also a concern. In addition, facilities will wear out quickly at a high temperature of 80° C. or higher due to acidic condition and the treatment under such high temperature is high energy consumption, so the process is uneconomical.

### CITATION LIST

### Patent Documents

Patent Document 1: Japanese unexamined patent publication No. H06-170380

Patent Document 2: Japanese patent No. 4077104

### Non-Patent Documents

Non-Patent Document 1: “Current Status and Prospects of High-technology Batteries” p. 24-29 (1998 Dec. 15) Kinki Chemical Association

### SUMMARY OF INVENTION

### Technical Problem

An object of the present invention is to provide a more easy, safe, and low cost process for sufficiently processing the highly toxic PF₅, preventing it from spreading into the environment, and recycling it. In particular, the present invention aims to provide an easy, safe and low cost process for treating PF₅ of a low concentration which cannot be recovered by cryogenic distillation method.

### Solution to Problem

The present inventors performed extensive studies to solve the above problem and found that the prevention of discharge or spread of a low concentration PF₅ into the environment is possible by efficiently absorbing the low concentration PF₅ under an acidic condition, adjusting its acidic concentration, then heating it for decomposition, recovering the obtained compounds of acid, such as hydrogen fluoride (HF) or phosphoric acid (H₃PO₄), or salts thereof, as a fluorine source and a phosphorous source, fixing those decomposition products to compounds including calcium (Ca) as fluorine-containing compounds or phosphorus-containing compounds, and thus, detoxifying PF₅.

The present invention provides a treatment process of PF₅ comprising an absorption step for inducing absorption of PF₅ by an acidic solution containing a specific acid, an adjustment step for appropriately adjusting an acid concentration of a solution obtained in the absorption step, and a thermolysis step for heating the solution obtained in the absorption step or the adjustment step to decompose it into an acidic mixture containing H₃PO₄ and HF.

The problem of the invention is solved by recovering the decomposition product obtained by the above process as valuable resources, such as fluorine source or phosphorous source, or fixing it to calcium compounds, etc., and thus, the discharge or spread of PF₅ into the environment is prevented, and reuse of PF₅ is made possible.

The treatment process of the present invention can also be performed against wastewater, etc. containing PF₅; and

The present invention provides at least the following embodiments.

[1] A treatment process of PF₅ comprising:

an absorption step for inducing absorption of PF₅ by an acidic solution containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (HPO₃F or HPO₂F₂) to obtain a solution containing PF₅A⁻ which is an ion composed of an acid-based anion A⁻ selected from F⁻, Br⁻, I⁻, H₂PO₄⁻, HPO₃F⁻, and PO₂F₂⁻ combined with PF₅; and

a thermolysis step for heating the solution obtained in the absorption step to 35° C. or higher and 75° C. or lower for 2 to 96 hours to decompose the solution PF₅A⁻ in the solution to form an acidic mixture containing at least one of F⁻ and PO₄³.

[2] A treatment process of PF₅ comprising:

an absorption step for inducing absorption of PF₅ by an acidic solution containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (HPO₃F or HPO₂F₂) to obtain a solution containing PF₅A⁻ which is an ion composed of an acid-based anion A⁻ selected from F⁻, Cl⁻, Br⁻, I⁻, H₂PO₄⁻, HPO₃F⁻, and PO₂F₂⁻ combined with PF₅;

an adjustment step for blowing in a gas containing 1 to 100 vol % of hydrogen chloride (HCl), or adding hydrochloric acid of a concentration of 1 to 36 wt % to the solution obtained in the absorption step to adjust a concentration of HCl in the solution to 1 to 36 wt %; and

a thermolysis step for heating the solution obtained in the adjustment step to 35° C. or higher and 75° C. or lower to decompose the solution.

[3] The treatment process according to either [1] or [2], wherein a concentration of PF₅ to be absorbed in the acidic solution in the absorption step is 0.00001 vol % (0.1 ppm) or higher and lower than 20 vol % (200,000 ppm).
[4] The treatment process according to either [1] or [2], wherein the acidic solution to be used in the absorption step contains 1 molar equivalent or higher of acid against an amount of PF₅ to be absorbed.
[5] The process according to [1], wherein the thermolysis step comprises heating the solution obtained in the absorption step for 2 to 96 hours to decompose PF₅A⁻ in the solution to form an acidic mixture containing at least one of F⁻ and PO₄³⁻.
[6] The process according to [2], wherein the thermolysis step comprises heating the solution obtained in the adjustment step for 2 to 96 hours to decompose PF₅A⁻ in the solution to form an acidic mixture containing at least one of F⁻ and PO₄³⁻.

### ADVANTAGEOUS EFFECTS OF INVENTION

The treatment process of phosphorous pentafluoride of the present invention enables recovery of PF₅ contained in the wastewater or exhaust gas, recovery of PF₅ contained in the wastewater or exhaust gas by decomposing it into phosphorous-containing compounds and fluorine-containing compounds, and further, recovery of PF₅ contained in the wastewater or exhaust gas by fixing it after decomposition to prevent PF₅ from spreading outside and further to recycle PF₅.

### DESCRIPTION OF EMBODIMENTS

The PF₅ gas treatment process of the present invention is described in detail below, but the embodiments of the present invention is not limited by the following.

1. Absorption Step

Firstly, PF₅ is subjected to absorption by an acidic solution. The common substance for absorbing acidic gas is water or an alkaline solution, but PF₅ has low solubility to water. In addition, a scrubber is commonly used with an alkaline absorbent, but it has poor absorption and it cannot sufficiently capture PF₅, so it is not efficient. The present invention may effectively capture PF₅ that has spread in gas by absorbing PF₅ using an acidic solution.

The acidic solution for absorption may be a solution that includes at least one acid selected from hydrogen fluoride (HF), hydrogen chloride (HCl), hydrogen bromide (HBr), hydrogen iodide (HI), phosphoric acid (H₃PO₄), and fluorophosphoric acid compound (HPO₃F or HPO₂F₂), but an aqueous solution containing HF and/or HCl would be more preferable from an economic view point. As mentioned above, an incorporation of sulfuric acid is not preferable since a large amount of calcium sulfate would be generated as industrial waste during neutralization. PF₅ is absorbed in an acidic solution as PF₅A⁻ ions. A⁻ is an acid-based anion contained in an acidic solution. When the acidic solution is HF, HCl, HBr, HI, H₃PO₄, HPO₃F, or HPO₂F₂ respectively, anions A⁻ may include F⁻, Cl⁻, Br⁻, I⁻, H₂PO₄⁻, HPO₃F⁻, or PO₂F₂⁻. The amount of acid is preferably 1 molar equivalent or higher against PF₅ to be absorbed. An amount lower than 1 molar equivalent would make the PF₅ absorption insufficient, and PF₅A⁻ ions would not be generated easily. The upper limit of the acid concentration is not particularly restricted, but a concentration equal to or lower than the saturation concentration of each acid is practical.

The solution obtained in the absorption step may be subsequently reused for the absorption step according to the concentration of the PF₅A⁻ ions, or it may be converted into a different compound by decomposition.

In addition, PF₅ to be absorbed in the acidic solution during the absorption step may be either gas or liquid, and it should preferably be contained at a concentration of 0.00001 vol % (0.1 ppm) or higher and lower than 20 vol % (200,000 ppm). When the concentration is higher than 20 vol %, it becomes more advantageous effort-wise and cost-wise to directly recover the material without performing the decomposition operation. In addition, there is not much need for a decomposition operation for a concentration lower than 0.00001 vol %, since the impact on the environment is sufficiently low.

Further, a gas preparation step and/or liquid preparation step may be included as a preliminary step to the absorption step to improve the absorption efficiency of PF₅ during the absorption step. In the gas preparation step and/or liquid preparation step, a liquid or gas compound containing at least one of chloride (Cl), phosphorous (P), and fluorine (F) are made to co-exist with PF₅ by any suitable means. This step can be performed by blowing PF₅ gas into a gas phase or a liquid phase containing Cl, P, and F.

2. Adjustment Step

Next, HCl is added to an acidic solution that has absorbed PF₅ to adjust pH. HCl may be added as gas or a hydrochloric acid solution. When HCl is added as gas, HCl in the gas may be adjusted freely in the range of 1 to 100 vol %. In addition, when HCl is added as hydrochloric acid, hydrochloric acid at a concentration of 1 to 36 wt % may be used. This step may be omitted by preliminary incorporating a suitable concentration of HCl as acid to the acidic solution. The HCl concentration in the acidic solution may preferably be adjusted to 1 to 36 wt %, which is about 1 to 3.5 pH. PF₅A⁻ ions are decomposed at a concentration lower than 1 wt %, but the decomposition rate decreases significantly. On the other hand, a concentration of 36 wt % or higher is not practical in view of the HCl solubility.

3. Thermolysis Step

By heating and agitating a solution from the absorption step which may be optionally preceded by an adjustment step, PF₅A⁻ ions are decomposed to HF and H₃PO₄. Heating means may be appropriately selected from previously known methods. The heating temperature is preferably 35° C. or higher and 75° C. or lower. PF₅A⁻ ions are decomposed at a temperature lower than 35° C., but the decomposition rate drops significantly. A temperature above 75° C. imposes consideration to heat resistance in the selection of the material of the facility, making the facility costly, so it is uneconomical. In addition, a temperature over 75° C. causes acidic components required for decomposing PF₅A⁻ ions to escape the system, so it reduces decomposition efficiency. The heating/agitation time should preferably be 2 hours or longer to about 4 days (96 hours).

4. Recovery Step

The obtained solution contains ions of HF and H₃PO₄, namely F⁻ and PO₄³⁻, so they may be fixed as a fluorine source and a phosphorous source and recovered as valuable resources, or they may be disposed as waste in accordance with their concentration, and the more economically advantageous option may be selected.

F⁻ and PO₄³⁻ may be respectively fixed as a fluorine source and a phosphorous source by a commonly well-known method. For example, it is possible to obtain a compound containing calcium fluoride (CaF₂), calcium phosphate (Ca₃(PO₄)₂), etc. by adding Ca(OH)₂ to the solution. Then, the compound may be treated by a common method.

The above methods enable the present invention to capture PF₅ in the acidic solution followed by decomposition to recover the result as valuable resources, or to fix the result to remove toxicity, and thereby prevent the spread of PF₅ into the environment or detoxify PF₅.

5. Object of Treatment

The treatment process of the present invention may be applied not just to PF₅ gas but also to wastewater that builds up when producing various products using PF₅, or wastewater that builds up when producing other products. There is no limit to the PF₅ concentration of the wastewater to be treated.

6. Specific Embodiments

For example, a treatment process of PF₅ including the following gas preparation step, absorption step, adjustment step and thermolysis step is given as a specific embodiment of the present invention.

A treatment process of a gas compound containing phosphorous and fluorine comprising:

(1) a gas preparation step for inducing coexistence of a gas compound containing at least one type of chlorine (Cl), phosphorous (P), and fluorine (F) with PF₅ to prepare a PF₅-containing gas compound;
(2) an absorption step for adding the PF₅-containing gas compound to an acidic solution (acidic solution containing an anion A⁻: F⁻, Cl⁻, Br⁻, I⁻, PO₄⁻, PO₃F⁻, and/or HPO₂F₂⁻) containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (HPO₃F or HPO₂F₂) to induce absorption of a PF₅ component to obtain an acidic solution containing PF₅A⁻; and
(3) an adjustment step for adding HCl-containing gas or hydrochloric acid to the acidic solution to adjust the solution to a HCl concentration of 1.0 to 36.0 wt %; and
(4) a thermolysis step for heating the acidic solution containing PF₅A⁻obtained in the adjustment step to 35° C. or higher and 75° C. or lower to decompose the solution to an acidic mixture containing HF and H₃PO₄.

Another specific embodiment is a treatment process of PF₅ comprising the following liquid preparation step, absorption step, adjustment step and a thermolysis step.

A treatment process of a liquid compound containing phosphorous and fluorine comprising:

(1) a liquid preparation step for inducing coexistence of a liquid compound containing at least one type of chlorine (Cl), phosphorous (P) and fluorine (F) with PF₅ to prepare a PF₅-containing liquid compound;
(2) an absorption step for adding the PF₅-containing liquid compound to an acidic solution (acidic solution containing an anion A⁻: F⁻, Cl⁻, Br⁻, I⁻, PO₄⁻, PO₃F⁻, and/or HPO₂F₂) containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (HPO₃F or HPO₂F₂) to induce absorption of a PF₅ component by the acidic solution to obtain an acidic solution containing PF₅A⁻; and
(3) an adjustment step for adding HCl-containing gas or hydrochloric acid to the acidic solution to adjust the solution to a HCl concentration of 1.0 to 36.0 wt %; and
(4) a thermolysis step for heating the solution obtained in the adjustment step to 35° C. or higher and 75° C. or lower to decompose the solution to an acidic mixture containing HF and H₃PO₄.

### EXAMPLES

The Examples of the present invention are described together with Comparative Examples, but the present invention is not limited to these Examples.

### Example 1

A 10 wt % HF solution (2 kg) was loaded into a PFA (copolymer of tetrafluoroethylene and perfluoroalkoxy ethylene) bottle equipped with an agitator with a capacity of 5 L, and 0.1 kg of PF₅ gas was blown into the solution. The outlet gas was analyzed with FT-IR (IG-1000 produced by Otsuka Electronics Co., Ltd.) while gas was blown in, and the gas was introduced at 0.1 to 0.5 L/min, which is a rate that allows substantially no PF₅ gas component to be detected in the outlet gas, and a PF₅F⁻ (i.e. PF₆⁻) ion-containing solution was prepared. The PF₅ concentration in the ion-containing solution was 5 wt %, and the concentrations of HF and HCl in the solution were respectively 10 wt % and 0 wt %.

The solution was transferred into a container with a capacity of 20 L, then 2 kg of a 30 wt % hydrochloric acid was added to the solution, and the container was put in a water bath of 60° C. for heating and agitation. After 24 hours, the solution was cooled to 20° C. and 13 kg of separately prepared 10 wt % lime hydrate slurry was gradually added to adjust the solution to pH 8.0. When the neutralized slurry was filtered with a filter press, 1 kg of solid and 16 kg of aqueous solution were obtained. The total amount of phosphorous in the aqueous solution was 3 ppm, and the pH was 7.9. No HCl gas is generated during the heating and agitation.

### Example 2

A mixture of 2 kg of 10 wt % HF solution and 2 kg of 30 wt % hydrochloric acid was loaded into a PFA bottle equipped with an agitator with a capacity of 5 L, and 0.1 kg of PF₅ gas was blown into the solution. The outlet gas was analyzed with FT-IR while gas was blown in, and the gas was introduced at 0.1 to 0.5 L/min, which is a rate that allows substantially no PF₅ gas component to be detected in the outlet gas, and a PF₅F⁻ (i.e. PF₆⁻) ion-containing solution was prepared. The PF₅ concentration in the ion-containing solution was 3 wt %, and the concentrations of HF and HCl in the solution were respectively 5 wt % and 15 wt %.

Subsequently, the solution was transferred into a container with a capacity of 20 L, and the container was put in a water bath of 40° C. for heating and agitation. After 72 hours, it was cooled to 20° C. and 13 kg of separately prepared 10 wt % lime hydrate slurry was gradually added to adjust the solution to pH 8.2. When the neutralized slurry was filtered with a filter press, 1 kg of solid and 16 kg of aqueous solution were obtained. The total amount of phosphorous in the aqueous solution was 4 ppm, and the pH was 8.1.

### Comparative Example 1

Water (4 kg) was loaded into a PFA bottle equipped with an agitator with a capacity of 5 L, and 0.1 kg of PF₅ gas was blown into the water. The outlet gas was analyzed with FT-IR while gas was blown in, and the inventors attempted to introduce gas at a rate that allows substantially no PF₅ gas component to be detected in the outlet gas, but PF₅ gas was always detected, and it was not possible to prepare PF₅F⁻ (i.e. PF₆⁻) ions by efficiently absorbing PF₅ gas.

### Comparative Example 2

A 1 wt % LiOH solution (4 kg) was loaded into a PFA bottle equipped with an agitator with a capacity of 5 L, and 0.1 kg of PF₅ gas was blown into the solution. The outlet gas was analyzed with FT-IR while gas was blown in, and the inventors attempted to introduce gas at a rate that allows substantially no PF₅ gas component to be detected in the outlet gas, but PF₅ gas was always detected, and it was not possible to quantitatively prepare PF₅F⁻ (i.e. PF₆⁻) ions by efficiently absorbing PF₅ gas.

### Comparative Example 3

A 30 wt % NaOH solution (4 kg) was loaded into a PFA bottle equipped with an agitator with a capacity of 5 L, and 0.1 kg of PF₅ gas was blown into the solution. The outlet gas was analyzed with FT-IR while gas was blown in, and the inventors attempted to introduce gas at a rate that allows substantially no PF₅ gas component to be detected in the outlet gas, but PF₅ gas was always detected, and it was not possible to quantitatively prepare PF₅F⁻ (i.e. PF₆⁻) ions by efficiently absorbing PF₅ gas.

1. A treatment process of PF₅ comprising:
an absorption step for inducing absorption of PF₅ by an acidic solution containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (H₂PO₃F or HPO₂F₂) to obtain a solution containing PF₅A⁻ which is an ion composed of an acid-based anion A⁻ selected from F, Cl⁻, Br⁻, I⁻, H₂PO₄⁻, HPO₃F⁻, and PO₂F₂⁻ combined with PF₅; and
a thermolysis step for heating the solution obtained in the absorption step to 35° C. or higher and 75° C. or lower for 2 to 96 hours to decompose PF₅A⁻ in the solution to form an acidic mixture containing at least one of F and PO₄³⁻.

2. A treatment process of PF₅ comprising:
an absorption step for inducing absorption of PF₅ by an acidic solution containing at least one acid selected from hydrogen fluoride (HF), hydrogen chloride (HCl), hydrogen bromide (HBr), hydrogen iodide (HI), phosphoric acid (H₃PO₄), and fluorophosphoric acid compound (H₂PO₃F or HPO₂F₂) to obtain a solution containing PF₅A⁻ which is an ion composed of an acid-based anion A⁻ selected from F⁻, Cl⁻, Br⁻, I⁻, H₂PO₄⁻, HPO₃F⁻, and PO₂F₂⁻ combined with PF₅;
an adjustment step for blowing in a gas containing 1 to 100 vol % of hydrogen chloride (HCl), or adding hydrochloric acid of a concentration of 1 to 36 wt % to the solution obtained in the absorption step to adjust concentration of HCl in the solution to 1 to 36 wt %; and
a thermolysis step for heating the solution obtained in the adjustment step to 35° C. or higher and 75° C. or lower to decompose the solution.

3. The treatment process according to claim 1, wherein a concentration of PF₅ to be absorbed in the acidic solution in the absorption step is 0.00001 vol % (0.1 ppm) or higher and lower than 20 vol % (200,000 ppm).

4. The treatment process according to claim 1, wherein the acidic solution to be used in the absorption step contains 1 molar equivalent or higher of acid against an amount of PF₅ to be absorbed.

5. (canceled)

6. The process according to claim 2, wherein the thermolysis step comprises heating the solution obtained in the adjustment step for 2 to 96 hours to decompose PF₅A⁻ in the solution to form an acidic mixture containing at least one of F and PO₄³⁻.

7. The treatment process according to claim 2, wherein a concentration of PF₅ to be absorbed in the acidic solution in the absorption step is 0.00001 vol % (0.1 ppm) or higher and lower than 20 vol % (200,000 ppm).

8. The treatment process according to claim 2, wherein the acidic solution to be used in the absorption step contains 1 molar equivalent or higher of acid against an amount of PF₅ to be absorbed.
